(19) United States
(12) Patent Application Publication
(10) Pub. No.: US 2011/0215670 A1
(43) Pub. Date: Sep. 8, 2011

(54) TIGHTENING DEVICE FOR END WINDING SUPPORTS OF AN ELECTRIC GENERATOR

(76) Inventors: Andre Arndt, Lupfig (CH); Francesco Stallone, Locarno (CH)

(21) Appl. No.: 13/030,318

(22) Filed: Feb. 18, 2011

(30) Foreign Application Priority Data
Mar. 3, 2010 (EP) 10155330.3

(51) Int. Cl. H02K 3/50

(52) U.S. Cl. 310/214

(57) ABSTRACT

The tightening device (7) for end winding supports of an electric generator includes a rod (10) supporting a wedge (11), a plurality of springs (14) and a nut (13). It also includes a spacer (15) provided between the wedge (11) and the nut (13), arranged to define the smallest axial distance between the wedge (11) and the nut (13). In addition, the opposite end of the rod (10) carries a fixed wedge (8)

This application claims priority under 35 U.S.C. § 119 to European Application No. 10155330.3, filed 3 Mar. 2010, the entirety of which is incorporated by reference herein.

### BACKGROUND

1. Field of Endeavor

The present invention relates to a tightening device for end winding supports of an electric generator.

2. Brief Description of the Related Art

In the following, reference to FIG. 1 is made.

FIG. 1 shows a stator 1 having stator bars 2.

Each stator bar 2 has a straight part 3 contained in a slot of the stator 1, and an end winding part 4 outside of the slots and connected to an end winding part of another stator bar.

Typically, the end winding parts 4 of the stator bars 2 are clamped together with clamping plates 30 and are supported by conical supports 5, 6 (usually having a ring shape) via tightening devices 7 that maintain the end winding parts 4 firmly connected to the supports 5, 6.

Traditionally the tightening devices 7 are provided with a rod 10 having at one side a fixed wedge 8 (this wedge 8 cannot move with respect to the rod 10) and at the other side a movable wedge 11 blocked by a nut 13, with one, or often more than one, spring 14 and a distance sleeve 25 inbetween.

During operation of the generator, the connected elements withstand setting effects that cause the wedge 11 to go forward pressed by the springs 14 (the nut 13 is usually fixed and cannot move); even if it is larger at the beginning of the generator lifetime, these setting effects continue over the whole generator lifetime.

For this reason, during periodical revisions the remaining load of the springs 14 of the tightening devices 7 must be checked and, when needed, the nuts 13 must be adjusted to bring the springs 14 to the correct design pre-compression.

Nevertheless, checking the remaining load of the springs 14 and adjusting of the nuts 13 to the correct position, to give the springs 14 the correct design pre-compression, is a very delicate operation that requires a very large amount of time.

In addition, since springs are typically made of glass fibres, an incorrect pre-compression (i.e., a too large pre-compression) could cause the springs to break.

### SUMMARY

One of numerous aspects of the present invention includes a tightening device by which the aforementioned problems of the known art are addressed.

Another aspect of the present invention includes a tightening device by which adjusting or screwing of the nuts, such that the springs are brought to the correct design pre-compression, is very fast and precise.

A further aspect of the invention is to provide a tightening device in which the springs cannot break during maintenance because of an incorrect pre-compression.

Advantageously, in preferred embodiments of the invention also measurement of the displacement due to the setting effects is very fast.

### BRIEF DESCRIPTION OF THE DRAWINGS

Further characteristics and advantages of the invention will be more apparent from the description of a preferred but non-exclusive embodiment of the tightening device, illustrated by way of non-limiting example in the accompanying drawings, in which:

FIG. 1 is a schematic view of a traditional tightening device connected to end winding supports;

FIG. 2 is a longitudinal section of a tightening device in embodiments of the invention in a tightened configuration;

FIG. 3 is a longitudinal section of the tightening device in embodiments of the invention in a loosened configuration;

FIG. 4 is a side view of a portion of the tightening device in embodiments of the invention in a tightened configuration (upper part of FIG. 4) and in a loosened configuration (lower part of FIG. 4); and

FIG. 5 is a longitudinal section of a tightening device in a different embodiment of the invention.

### DETAILED DESCRIPTION OF EXEMPLARY EMBODIMENTS

With reference to the figures, a tightening device 7 for end winding supports of an electric generator is illustrated.

The tightening device 7 includes a rod 10 supporting a movable connecting element such as a wedge 11 (in particular the rod 10 in inserted into a through hole of the wedge 11).

The rod 10 also supports springs 14, resting against the largest base of the wedge 11, and a blocking element, such as a nut 13 screwed on a threaded terminal portion of the rod 10.

In addition, a spacer 15 is provided between the wedge 11 and the nut 13, arranged to define the smallest axial distance (i.e., the distance along the rod 10) between the wedge 11 and the nut 13.

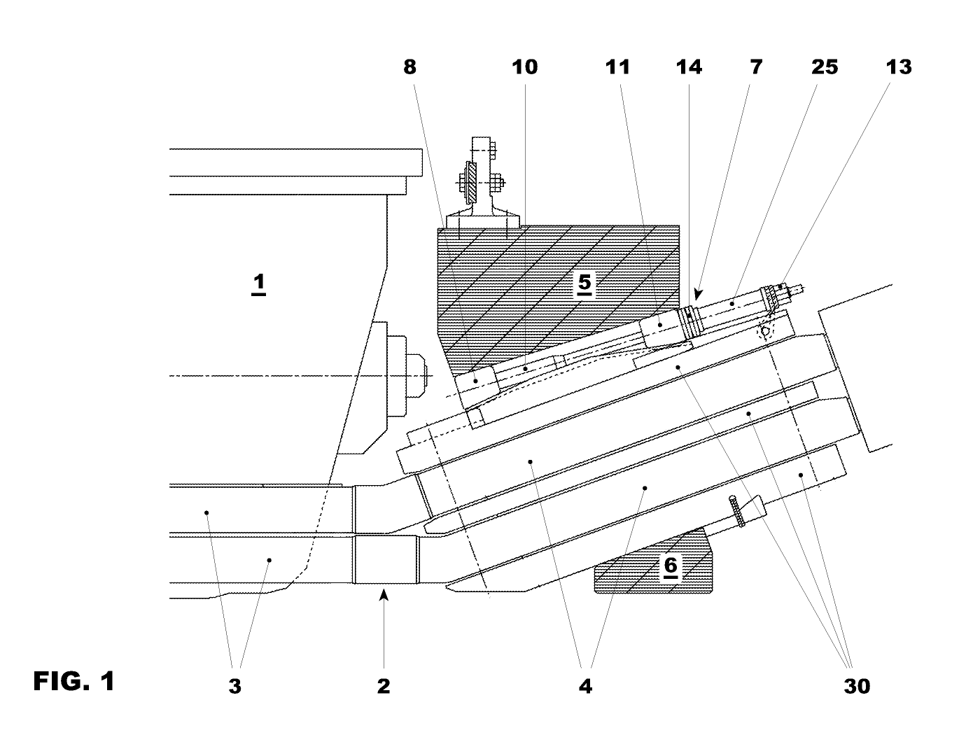

Typically, between the spacer 15 and the nut 13, a distance sleeve 25 is provided (not shown), similar to the one shown in FIG. 1.

The spacer 15 includes a housing wherein the springs 14 are housed; this housing has an outer element 17 encircling an inner element 18.

In particular, the outer and the inner element 17, 18 have coaxial cylindrical walls 17w, 18w.

For example the outer element may be formed in one piece with the wedge 11 or nut 13 and/or the inner element 18 may be formed in one piece with the nut 13 and/or wedge 11; FIG. 5 shows an example in which the outer element 17 is formed in one piece with the wedge 11 and the inner element 18 is formed in one piece with the nut 13.

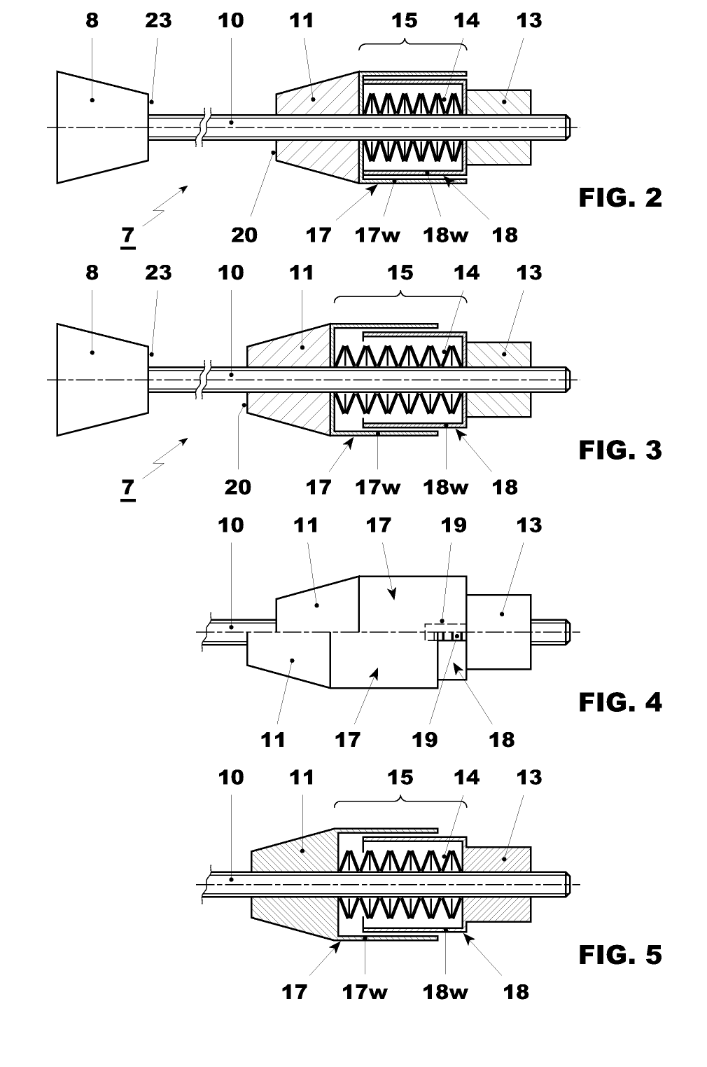

In further embodiments the outer element 17 and/or the inner element 18 are cup shaped pieces (FIGS. 2 and 3 show the outer and inner element that are defined by cup shaped pieces).

The coaxial cylindrical walls 17w, 18w of the outer and inner elements 17, 18 are slidingly connected together, such that the element 15 may expand because of the setting effects and may be tightened during maintenance.

Advantageously, the cylindrical wall 18w of the inner element 18 is provided with a ruler 19; correspondingly, the outer element 17 has an indicator, indicating the displacement on the ruler 19; preferably the indicator is defined by an end border of the cylindrical wall 17w.

As shown, the wedge 11 has its smallest base 20 that is opposite the springs 14 and the nut 13 associated to it.

In addition, the rod 10 carries, at an end opposite the one having the arrangement with the wedge 11, the springs 14, the nut 13 and the spacer 15, a further fixed connecting element such as a further wedge 8 with its smallest base 23 towards the arrangement of the wedge 11, springs 14, nut 13 and spacer 15.

This further wedge 8 is fixed to the rod 10 for example by glue.

The operation of the tightening device 7 is apparent from that described and illustrated and is substantially the following.

After assembling (or after maintenance) the tightening devices 7 are in the configuration of FIG. 2, i.e., the outer and the inner elements 18, 17 are tightened and the border of the wall 18w rests against the ceiling of the outer element 17.

Bringing the tightening device into this configuration is easy and fast, since the operators only have to screw the nut 13 until the spacer 15 is tightened; thus no force or distance measures are needed to check the pre-compression of the springs 14. In addition, since correct pre-compression is achieved when the spacer 15 is tightened, no risk of spring breakage exists.

During operation, because of the setting effects, the wedge 11 moves forwards (the nut 13 is fixed); thus the tightening device 7 turns its configuration into the one of FIG. 3.

When in this configuration, measuring the displacement (to ascertain whether maintenance operations are needed or not) is easy and fast, since the operators only have to look at the ruler 19 onto which the border of the wall 17w indicates the displacement. In case the relevant parts are not easily accessible, these operations may also be carried out using a mirror connected to the end of a bar.

Then, if maintenance is needed, the nut 13 can be screwed until the spacer 15 is tightened.

Naturally, even if the nut 13 is secured by gluing, during maintenance operation (to tighten the spacer 15) it is disconnected from the rod 10 to be then (after maintenance) connected again thereto.

Naturally the features described may be independently provided from one another.

The tightening device conceived in this manner is susceptible to numerous modifications and variants, all falling within the scope of the inventive concept; moreover all details can be replaced by technically equivalent elements.

In practice the materials used and the dimensions can be chosen at will according to requirements and to the state of the art.

### REFERENCE NUMBERS

1 stator

2 stator bar

3 straight part of 2

4 end winding part of 2

5, 6 supports

7 tightening device

8 fixed wedge

10 rod

11 wedge

13 nut

14 spring

15 spacer

17 outer element

17w wall of 17

18 inner element

18w wall of 18

19 ruler

20 smallest base of 11

23 smallest base of 8

25 distance sleeve

30 clamping plates

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A tightening device for end winding supports of an electric generator, the device comprising:
a rod, at least one connecting element, at least one spring, and a blocking element, wherein the rod supports the at least one connecting element, the at least one spring, and the blocking element;
a spacer between the at least one connecting element and the blocking element, the spacer configured and arranged to define a smallest axial distance along the rod between the at least one connecting element and the blocking element.

2. A tightening device as claimed in claim 1, wherein the connecting element comprises a wedge.

3. A tightening device as claimed in claim 1, wherein the spacer comprises a housing in which the at least one spring is at least partially housed.

4. A tightening device as claimed in claim 3, wherein said housing comprises an outer element and an inner element, the outer element encircling the inner element.

5. A tightening device as claimed in claim 4, wherein both the outer element and the inner element have coaxial cylindrical walls.

6. A tightening device as claimed in claim 5, wherein said coaxial cylindrical walls of the outer element and the inner element are slidingly connected together.

7. A tightening device as claimed in claim 4, wherein the outer element and the inner element are slidingly connected together.

8. A tightening device as claimed in claim 6, wherein:
the cylindrical wall of the inner element comprises a ruler; and
the outer element comprises an indicator configured and arranged to indicate the displacement of the outer element relative to the inner element on said ruler.

9. A tightening device as claimed in claim 8, wherein said indicator is defined by an end border of the cylindrical wall of the outer element.

10. A tightening device as claimed in claim 1, wherein:
the rod includes a threaded terminal portion; and
said blocking element comprises a nut screwed on the threaded terminal portion of the rod.

11. A tightening device as claimed in claim 2, wherein said wedge has a smallest base opposite the at least one spring and the blocking element.

12. A tightening device as claimed in claim 1, wherein:
the rod comprises first and second ends, the rod carrying the blocking element adjacent said first end;
the at least one connecting element comprises first and second connecting elements, the second connecting element being carried by the rod adjacent said second end, the second connecting element having a large base and a small base, the small base being oriented towards the first end.

13. A tightening device as claimed in claim 12, wherein the second connecting element comprises a wedge.

14. A tightening device as claimed in claim 13, wherein said wedge is fixed to the rod.

15. A tightening device as claimed in claim 4, wherein at least one of the outer element and the inner element comprise cup-shaped pieces.
